(19) United States
(12) Patent Application Publication
(10) Pub. No.: US 2010/0031981 A1
(43) Pub. Date: Feb. 11, 2010

(54) TENSIONING DEVICE FOR A CONVEYOR DEVICE

(76) Inventors: Bruno Gaus, Offenburg (DE); Axel Breitschuh, Offenburg (DE)

Correspondence Address: Muncy, Geissler, Olds & Lowe, PLLC, P.O. BOX 1364, FAIRFAX, VA, 22038-1364, US

(21) Appl. No.: 12/116,230

(22) Filed: May 7, 2008

Related U.S. Application Data
(60) Provisional application No. 60/942,202, filed on Jun. 5, 2007.

(30) Foreign Application Priority Data
May 7, 2007 (DE) 10 2007 021 255.2

(51) Int. Cl. A47L 15/42; B65G 23/44

(52) U.S. Cl. 134/124; 198/814

(57) ABSTRACT

A cleaning machine is provided, in particular a pass-through dishwasher, with a continuous conveyor belt for holding dishes, general containers or articles which are transported through the cleaning machine in the transportation direction, wherein a tensioning apparatus can be easily operated from above in the entry or exit region of the cleaning machine.

This nonprovisional application claims priority to German Patent Application No. 10 2007 021 255.2, which was filed in Germany on May 7, 2007, and to U.S. Provisional Application No. 60/942,202, which was filed on Jun. 5, 2007, and which are both herein incorporated by reference.

### BACKGROUND OF THE INVENTION

1. Field of the Invention

The present invention is directed to a cleaning machine, in particular a pass-through dishwasher, with a continuous conveyor belt for holding dishes, general containers or articles which are transported through the cleaning machine

2. Background of the Invention

Cleaning machines, for example machines which are used for cleaning dishes, general containers and the like, can be equipped with a preferably continuous belt for transporting the items to be cleaned through the machine. This conveyor belt has a certain tension applied to it during operation. Secure engagement of the tooth system of the drive wheels on the conveyor belt can be ensured as a result. Pretensioning the conveyor belt also ensures that the conveyor belt does not sag. This ensures that the items to be cleaned, for example dishes, are transported uniformly, that is to say at a uniform transportation speed, in particular without jolts. The conveyor belt is currently tensioned in a tensioning station. After the cleaning machine is installed, but before it is commissioned, the conveyor belt is inserted into said cleaning machine. The correct tension then has to be set on the conveyor belt. The tension of the conveyor belt falls over the course of time due to wear on the conveyor belt during operation. In order to counteract this, the conveyor belt is tensioned at regular intervals, for example as part of regular machine servicing. After a long period of use, it may be necessary under certain circumstances to replace the conveyor belt in the machine by a new one on account of excessive abrasion and wear phenomena. The tension of the conveyor belt can be completely relieved for the purpose of removing said conveyor belt.

In the case of embodiments of pass-through dishwashers known from the convnetional art, the conveyor belt is tensioned, for example, directly manually by hand. The tensioned position of the conveyor belt is defined by means of two external deflection disks. One deflection disk is in each case located on the right and on the left in the entry or exit region of the cleaning machine. The external deflection disks are fixed, for example, by hexagonal screws. It is necessary to reach through the conveyor belt in order to reach these screws. The opening in the conveyor belt is very narrow, with the result that accessibility to said hexagonal screws is extremely cumbersome. Furthermore, both when fitting the conveyor belt and during regular servicing operations, the servicing engineer has to simultaneously apply the tensioning force to the belt, displace the external deflection disks and fasten them again by tightening the hexagonal screws. This means that at least two operating forces are required for this operation, and this entails considerable costs.

In further prior art embodiments, a long, horizontal hexagonal screw is in each case arranged on the right and on the left of the conveyor belt. A continuous tensioning pin is therefore moved and fixed in the horizontally in the machine and, in this way, the conveyor belt is pretensioned from the front face of the entry or exit region. The accessibility to these hexagonal screws is provided solely at the front face of the entry or exit region of the machine. If further components of the entire system are located directly at this location, for example conveying devices, the conveyor belt can no longer be readily tensioned or removed since these components, which impair accessibility, would first have to be removed.

In a further embodiment, in which the tensioning screws are arranged at the front face for the reasons given above, a complex solution with tensioning screws which are arranged in the interior of the entry or exit region of the machine is performed. In this case, it is likewise necessary—as already described in the other context—to reach through the conveyor belt, with the result that the above-described disadvantages with regard to accessibility arise.

### SUMMARY OF THE INVENTION

It is therefore an object of the present invention to tension a continuous conveyor medium, for example a conveyor belt, to avoid the above-described disadvantages with regard to accessibility, mounting and servicing and costs.

The invention proposes a tensioning mechanism which is very easily accessible from the top of the entry or exit region of the pass-through dishwasher. Furthermore, the mechanism proposed according to the invention can be easily operated by one person, with the result that intervention by two people, particularly for applying a pretensioning force to the medium which is configured as a continuously revolving conveyor belt, is obsolete.

In a first embodiment, the tensioning mechanism proposed according to the invention can be configured such that the tensioning pin is held between opposite guides. The guide comprises a catch which is pressed against a toothed rack by a spring. If, after application and closure of the conveyor belt, the tensioning pin is displaced horizontally to the right, for example due to direct manual intervention, the toothed rack slides under the catch. If the required tension is reached in the conveyor belt, manual intervention at the tensioning pin can be stopped. Without further intervention, the tensioning pin is firmly held in the reached position by the toothed rack and the catch. The conveyor belt can be retensioned, as may be required, after a certain operating time in the same way. If, after a relatively long operating time, the tensioning path is exhausted and the conveyor belt has to be replaced by a new one, the spring can be relieved of tension by operating a screw and the catch can be lifted out of the toothed rack. As a result, the toothed rack is free and the tensioning pin can be displaced horizontally to the left to such an extent that the worn-out conveyor belt can be removed and replaced by a new one. The operating steps listed above can be executed easily from above, without attachments on the front face of the cleaning machine which may cause problems preventing installation and removal and having to be removed first.

In a further embodiment of the tensioning mechanism proposed according to the invention, the catch is arranged on a pivotable lever. In order to relieve the tension of the conveyor belt, the lever can be pressed through an opening in the stand. On account of this movement, the catch is moved out of the toothed rack against the force of a spring and the tensioning pin can freely move horizontally in its guide. In order to prevent the catch from unintentionally latching in, it may be equipped with retaining elements, for example a hook 15, with which the catch can be retained in the unlatched position.

In a further embodiment of the tensioning mechanism proposed according to the invention, the tensioning pin is held in a guide. A traction means which is guided by means of a deflection device to a nut engages on this tensioning pin. The nut, in turn, engages with a tensioning screw. After application and closure of the conveyor belt, the two tensioning screws are moved in such a way that the nut moves upward along the thread. This movement is transmitted by the traction means to the guide and therefore to the tensioning pin. The conveyor belt can be tensioned in the machine by simple manual actions, and likewise any retensioning which may be required after a certain operating time can be performed in the same way. The traction means may be, for example, a cable or a chain or else a coupling gear mechanism.

The embodiments of the solution proposed according to the invention which are briefly outlined above share the common feature that the operating elements are all located outside regions of a pass-through dishwasher which are subject to soiling. Furthermore, the operating elements of the tensioning mechanisms are provided at very easily accessible locations on the machine and these can be operated by servicing engineers without too much effort having to be expended. Furthermore, the tensioning mechanisms proposed according to the invention which serve for pretensioning, retensioning and installing and removing a conveyor belt are very cost-effective to produce and also cost-effective to mount.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exit region of a belt-conveyor dishwasher,

FIG. 2 shows details of a first embodiment of the tensioning mechanism according to an embodiment of the present invention,

FIG. 3 shows a further embodiment of the tensioning mechanism proposed according to the invention, and

FIG. 4 shows a further embodiment of the tensioning mechanism proposed according to the invention whose guide is acted on by a traction means.

### DETAILED DESCRIPTION

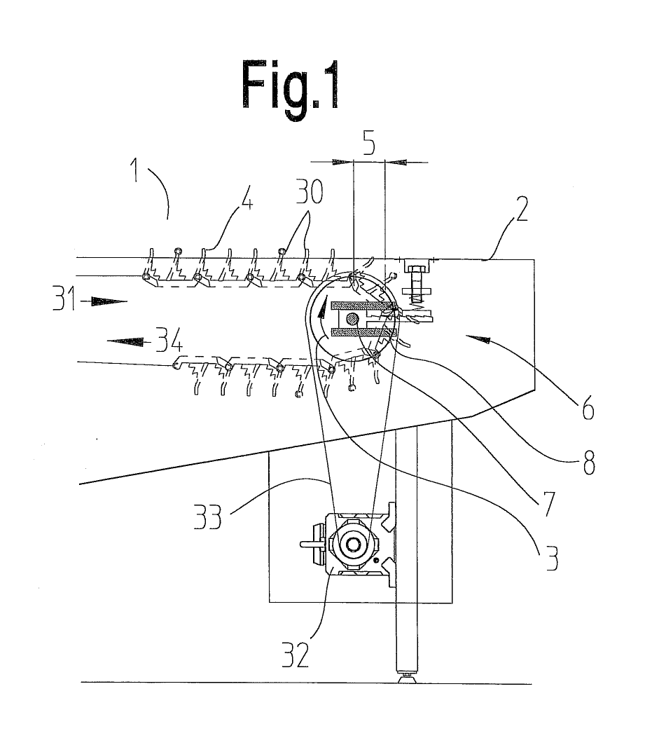

The illustration according to FIG. 1 shows an exit region of a cleaning machine, in particular a belt-conveyor machine which is provided in the form of a pass-through dishwasher.

FIG. 1 shows a tensioning mechanism which is accessible from the top of either an entry or an exit region 1 of a cleaning machine, in particular a dishwashing machine. FIG. 1 shows that the exit region 1 of the cleaning machine comprises a stand or frame 2 on which a deflection pulley 3 which is driven in the illustration according to FIG. 1 is held, with a conveyor medium 4 which is in the form of a continuous conveyor belt revolving about said deflection pulley. This conveyor medium is conveyed in the conveying direction 31 by running on the driven deflection pulley 3 and comprises a number of fingers 30 which are arranged at regular intervals one behind the other in the conveying direction 31. The deflection pulley 3 illustrated in FIG. 1 is driven by a drive 32, which is arranged beneath the exit region 1 of the cleaning machine, by means of a transmission means 33 which may be a belt or a chain. The items to be cleaned, which are in the form of dishes, pots and pans, containers or the like, can be placed on the individual fingers 30 of the conveyor belt 4; alternatively, racks which contain the pre-sorted items to be cleaned can be fitted on the fingers 30 of the continuous, revolving conveyor belt 4.

As can further be seen in the illustration according to FIG. 1, the driven deflection pulley 3 is held on a tensioning pin 7 in a guide 8.

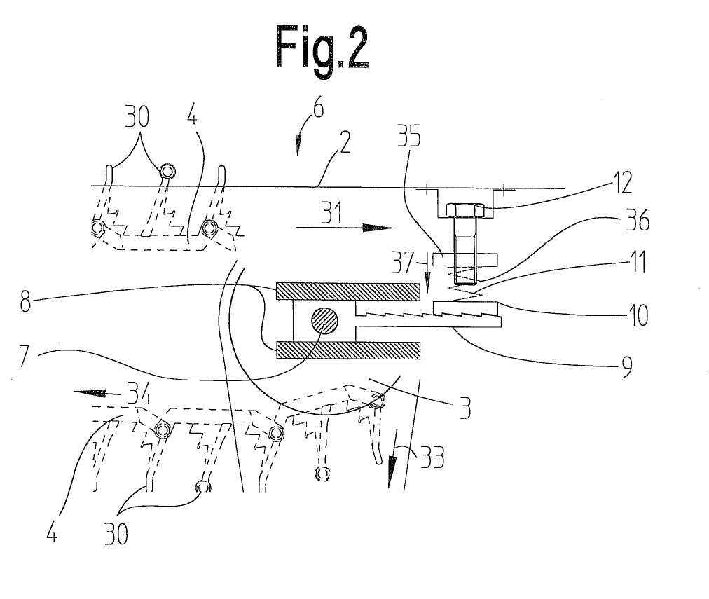

A first embodiment of the tensioning mechanism proposed according to the invention is denoted by reference symbol 6 and is illustrated in detail in FIG. 2.

The illustration according to FIG. 2 shows that, in its first embodiment, the tensioning device 6 comprises the toothed rack 9 which is connected to the bearing of the tensioning pin or the drive shaft 7. The bearing of the tensioning pin or the drive shaft 7 is displaceably mounted between two guide faces of the guide 8 and can be displaced over the tensioning path indicated by reference symbol 5 in FIG. 1.

The toothed rack 9 interacts with a catch 10. For its part, the catch 10 is acted on in the pretensioning direction 37 by a spring 11 which is supported on a stop 35 of a screw 12. The screw 12 is accessible from the top of the exit region 1 according to the illustration in FIG. 2 and can be operated by a simple key. When the screw 12 of the first embodiment 6 of the tensioning apparatus is correspondingly turned, the stop 35 which is arranged on the external thread of the screw 12 is displaced downward in the vertical direction, so that the force in the pretensioning direction 37 which acts on the spring which is acted on by the stop 35 is increased. This also has the effect of increasing the force which acts on the catch 10 which engages on the upper face of the toothed rack 9, that is to say on its tooth system. The first embodiment 6 of the tensioning device which is mounted on the stand or in the side frame 2 in FIG. 2 is in each case fitted on the right-hand side and left-hand side of the tensioning pin or of the drive shaft 7. If, after application and closure of the individual elements of the conveyor medium 4, which is preferably in the form of a continuous conveyor belt, the tensioning pin or the drive shaft 7 is displaced to the right by direct manual action, the toothed rack 9 moves through beneath the catch 10, which is correspondingly provided with a mating tooth system, by way of its toothed upper face. If the required tension of the conveyor medium, which is preferably in the form of a continuous conveyor belt 4, is reached, the manual action on the tensioning pin 7 or the drive shaft 7 can be stopped, and said tensioning pin or drive shaft is firmly held in the previously manually set position reached by the interengaging catch 10 and toothed rack 9. Tensioning of the conveyor medium, which is preferably in the form of a continuous conveyor belt, is therefore executed by a simple manual action. Any retensioning which may become necessary after a certain operating time can be performed in the same way.

If, for example after a relatively long operating time, the tensioning path 5 (cf. illustration according to FIG. 1) is exhausted and the conveyor belt 4 has reached its wear limit and has to be replaced, the spring 11 can be relieved of tension by a corresponding vertically upward movement of the stop 35 by operating the screw 12, so that the catch 10 can be lifted out of the toothed rack 9. As a result, the toothed rack 9 is free and the tensioning pin 7 or the drive shaft 7 can be displaced in the guide 8 to the left to such an extent that the conveyor belt 4 which has reached its wear limit can be removed and replaced by a new one.

On account of the configuration of the first embodiment 6 of the tensioning device, these operating steps can be executed from the top of the exit region 1 without attachments which may possibly be fitted on the front face of the stand or frame 2, which is illustrated in FIG. 1, of the exit region 1 of the cleaning machine having to be removed.

FIG. 2 shows that the driven deflection pulley 3 runs, on account of the transmission means 33 which is preferably a belt or a chain, in the conveying direction 31 of the revolving continuous conveyor medium 4 which is preferably in the form of a continuous conveyor belt. The respective guide faces of the guide 8 are arranged on the stand or in the frame 2 in the exit region 1, so that the bearing in which the tensioning pin or the drive shaft 7 is held can be displaced in the horizontal direction. The tensioning pin or the drive shaft 7 on which the drive wheel or a driven deflection pulley 3 is held is accordingly not firmly mounted in the stand or frame of the exit region 1 of the cleaning machine but can be displaced in relation to it in the tensioning direction or tension-relieving direction.

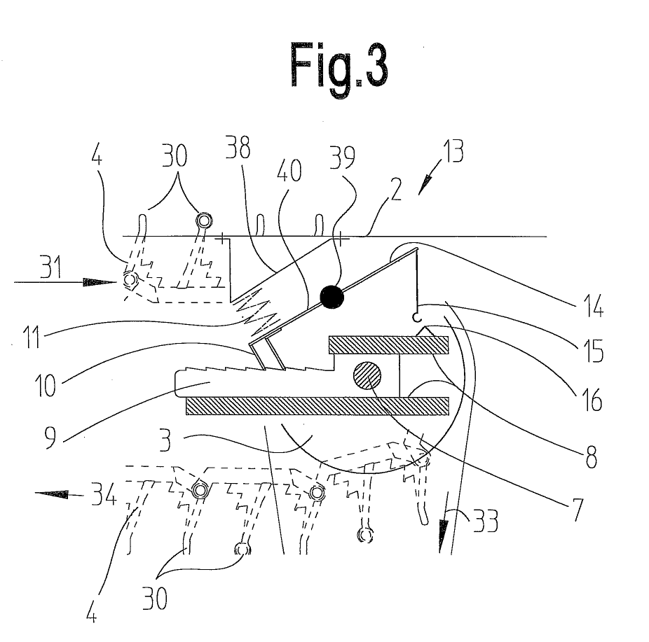

FIG. 3 shows a further embodiment of the tensioning mechanism proposed according to the invention.

As can be seen in the illustration according to FIG. 3, a second embodiment 13 of the tensioning mechanism comprises a lever 14 which is rotatably mounted about a pivot pin 39. A second lever arm 40, which has a catch 10 which engages in the tooth system on the upper face of the toothed rack 9, is located on the lever 14. Analogously to the embodiment of the guide 8 according to FIGS. 1 and 2, guide faces 8, which extend in the horizontal direction and in which the drive shaft or the tensioning pin 7 can be displaced by way of its bearing and the toothed rack 9 integrally formed on it, are formed on a side cheek of the stand or frame 2. As shown in the illustration according to FIG. 3, the second lever arm 40 is pretensioned in the counterclockwise direction by means of the spring 11. The spring 11 is supported on a support face 38, so that the catch 10 at the tip of the second lever arm 40 engages in the tooth system of the toothed rack 9 and prevents longitudinal movement of said toothed rack. Although the illustration according to FIG. 3 illustrates only one side of the stand 2 or the frame of the cleaning machine, the drive shaft or tensioning pin 7 extends perpendicular to the plane of the drawing as far as the second side of the stand, with two deflection pulleys or drive wheels 3 being held on the tensioning pin or drive shaft 7.

If the conveyor medium 4, which is preferably in the form of a continuous conveyor belt, illustrated in FIG. 3 is to be relieved of tension, the servicing engineer presses, for example, the operating lever 14, so that the second lever arm 40, together with the catch 10 formed at its tip, is deflected against the action of the spring 11. Longitudinal movement of the toothed rack 9 is enabled as a result. The bearing of the drive shaft or the tensioning pin 7, which, as a whole, can be displaced on this integrally formed toothed rack 9 between the faces of the guide 8, can therefore move freely. In order to ensure that the catch 10 does not unintentionally latch into the toothed rack 9 or its tooth system again, said catch can be equipped, for example, with retaining elements, for example a hook 15 or the like which, in conjunction with an eye 16 or the like, permits the catch 10 to be held in an unlatched position, and this considerably simplifies handling of the tensioning apparatus which is illustrated in its second embodiment in FIG. 3 during removal.

The deflection pulley or the drive wheel 3 is not directly firmly mounted on the side cheek of the stand or the frame 2 in the exit region or in the entry region 1 of the cleaning machine in the second embodiment 13, which is illustrated in FIG. 3, of the tensioning mechanism either. On account of the configuration of the guide 8 containing two guide faces which extend parallel to one another in the horizontal direction, parallel displacement of the toothed rack 9 and therefore of the bearing for the tensioning pin or the drive shaft 7 in the horizontal direction is made possible after the catch 10 on the second lever arm 40 is unlatched.

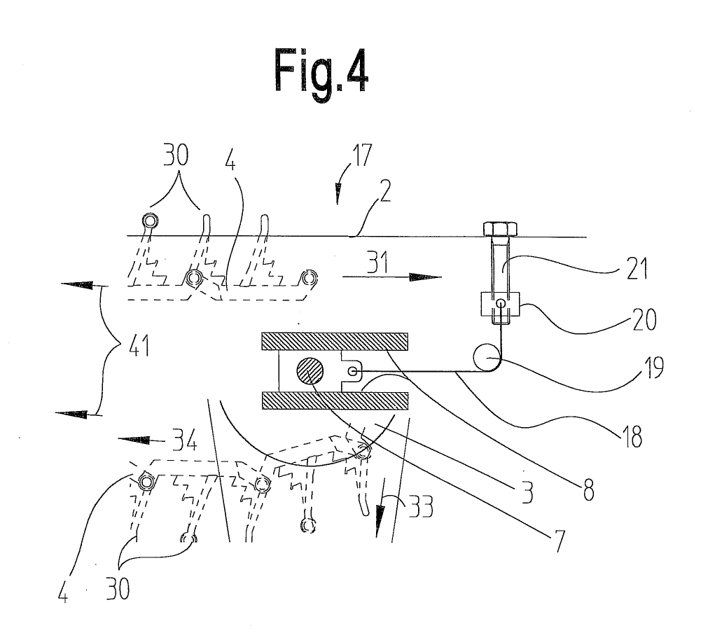

A further embodiment of the tensioning mechanism proposed according to the invention can be seen in the illustration according to FIG. 4.

The tensioning pin or drive shaft 7 is held in a bearing which is displaceably held in the guide 8 according to this embodiment too. The guide 8 comprises two guide faces which extend substantially parallel to one another in the horizontal direction. On account of the inherent weight of the conveyor medium 4, which is preferably in the form of a continuous conveyor belt, a traction force, indicated by reference symbol 41, is exerted on the bearing in which the tensioning pin or the drive shaft 7 of the deflection pulley or the drive wheel 3, in which the balance is maintained by a traction force in a traction means 18, is mounted. The traction means 18 may be a cable, a chain, a coupling gear mechanism or the like. As can be seen in the illustration according to FIG. 4, the traction means 18 is guided around a deflection device 19 at which it is deflected from the horizontal direction to the vertical direction. The traction means is fixed to a nut 20 which, in turn, is guided on the external thread of a tensioning screw 21.

As can be seen from the embodiment according to FIG. 4, increasing the inherent tension and preventing sagging of the conveyor medium 4, which is preferably in the form of a continuous conveyor belt, has the effect that a torque is applied to the tensioning screw 21 which has a tool attachment, for example in the form of a hexagonal head. When the tensioning screw 21 is turned, the nut 20 held on said tensioning screw moves upward in the vertical direction, so that the traction means 18 is tensioned. The tensioning force of said traction means is changed over from the vertical direction to the horizontal direction at the deflection device 19. On account of the increased traction force in the traction means 18, the bearing, together with the tensioning pin or drive shaft 7 held in it, are displaced to the right in the horizontal direction in the guide 8, so that the tensioning force in the individual elements of the conveyor medium 4, which is preferably in the form of a continuous conveyor belt, increases.

For the sake of completeness, it should be mentioned that the deflection pulley 3 is driven in the conveying direction 31 by the transmission means 33. The transmission means 33 may be a number of belts or a chain or the like which is driven by an electric drive 32 which is illustrated in FIG. 1 and arranged beneath the exit region or the entry region 1 of the cleaning machine. The third embodiment, which is illustrated in FIG. 4, of the tensioning mechanism proposed according to the invention is denoted by reference symbol 17.

All the embodiments of the tensioning mechanism illustrated in conjunction with FIGS. 2-4 share the common feature that their operating elements 12, 14, 21 are located in the exit region or entry region 1 of the cleaning machine outside regions which may possibly be subject to soiling by dirt and food residues. In addition, all the operating means 12, 14, 21 are located in locations in the cleaning machine which are very easily accessible from the top and can be directly operated by the servicing engineer without a great deal of effort or exposing work.

The embodiments, which are illustrated in the illustration according to FIGS. 2-4, of the tensioning mechanism proposed according to the invention are further distinguished by cost-effective production and, in particular, simple mounting. Retensioning work on the continuous conveyor belt 4, which work is required at regular intervals depending on the loading of the conveyor medium which is preferably in the form of a revolving conveyor belt, can be performed very easily and cost-effectively and in a highly user-friendly manner from the top of the exit region 1 or the entry region 1, without attached devices having to be removed.

All the embodiments, which are illustrated in conjunction with FIGS. 2-4, of the tensioning mechanisms share the common feature that the drive wheel or deflection pulley denoted by reference symbol 3 may also be designed as a deflection element which does not rotate about its pin 7. In this case, it is in the form of, for example, a semicircular disk which can be displaced only horizontally in the longitudinal direction of the machine.

Furthermore, all the embodiments, which are illustrated in FIGS. 2-4, of the tensioning mechanisms share the common feature that said tensioning mechanism can also be constructed in mirror-image fashion across an imaginary horizontal plane.

As a result, it would be possible to reach the operating elements 12, 14, 21 from the bottom of the machine instead of from the top of the machine, as is illustrated in FIGS. 2-4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning machine comprising:
a continuous conveyor belt for holding dishes, general containers or articles that are transported through the cleaning machine in a transportation direction; and
a tensioning apparatus being operable from above an entry or exit region of the cleaning machine, the tensioning apparatus tensioning the continuous conveyor.

2. A cleaning machine comprising:
a continuous conveyor belt for holding dishes, general containers or articles that are transported through the cleaning machine in a transportation direction; and
a tensioning apparatus being operable from below an entry or exit region of the cleaning machine, the tensioning apparatus tensioning the continuous conveyor.

3. The cleaning machine as claimed in claim 1, wherein the conveyor medium, which is preferably in the form of a continuous conveyor belt, is guided around drive wheels or around deflection pulleys whose tensioning pin or drive shaft is arranged in the entry or exit region such that they can be displaced in a horizontal direction.

4. The cleaning machine as claimed in claim 1, wherein the conveyor medium, which is preferably in the form of a continuous conveyor belt, is guided around deflection elements which do not rotate about a pin and which are arranged in the entry or exit region such that they can be displaced in the horizontal direction.

5. The cleaning machine as claimed in claim 1, wherein the tensioning device has bearings for the tensioning pin or drive shaft, which bearings are displaceably mounted in a guide.

6. The cleaning machine as claimed in claim 1, wherein the tensioning pin of the tensioning device is displaceably mounted directly in a guide.

7. The cleaning machine as claimed in claim 1, wherein the guide is substantially in the form of a horizontal guide and is arranged within side cheeks of the entry or exit region of the cleaning machine.

8. The cleaning machine as claimed in claim 1, wherein the conveyor belt can be tensioned without tools, and wherein the tensioning device is designed such that the pretension achieved is automatically maintained.

9. The cleaning machine as claimed in claim 1, wherein the tensioning apparatus has a toothed rack, which interacts with a pretensioned catch that can be released.

10. The cleaning machine as claimed in claim 9, wherein the toothed rack, with the bearing of the drive shaft or of the tensioning pin, can be horizontally displaced in the guide.

11. The cleaning machine as claimed in claim 9, wherein the catch, which interacts with the toothed rack is operated either by a stop, which acts on a spring, or by a lever, which moves about a pivot pin.

12. The cleaning machine as claimed in claim 11, wherein the spring, which acts on the catch, is supported on a support face.

13. The cleaning machine as claimed in claim 11, wherein the stop, which acts on the spring is held on a screw.

14. The cleaning machine as claimed in claim 9, wherein the catch is prevented from latching back onto the toothed rack by retaining elements.

15. The cleaning machine as claimed in claim 5, wherein the tensioning pin or the drive shaft of the tensioning device is tensioned by a traction device.

16. The cleaning machine as claimed in claim 15, wherein the traction device is in the form of a cable, chain or coupling gear mechanism.

17. The cleaning machine as claimed in claim 15, wherein the traction device is deflected from a horizontal direction to a vertical direction.

18. The cleaning machine as claimed in claim 1, wherein a pretension in the conveyor belt can be relieved without the use of tools.

19. The cleaning machine as claimed in claim 1, wherein inner faces of the exit and entry region are designed to be completely smooth.

20. The cleaning maching as claimed in claim 1, wherein the cleaning machine is a pass-through dishwasher
